(19) United States
(12) Patent Application Publication
(10) Pub. No.: US 2014/0149147 A1
(43) Pub. Date: May 29, 2014

(54) SYSTEMS AND METHODS FOR PROVIDING GROUP INSURANCE

(71) Applicant: Terrance Luciani, Monroe Township, NJ (US)

(72) Inventor: Terrance Luciani, Monroe Township, NJ (US)

(21) Appl. No.: 14/092,255

(22) Filed: Nov. 27, 2013

Related U.S. Application Data
(60) Provisional application No. 61/730,309, filed on Nov. 27, 2012.

(51) Int. Cl. G06Q 40/00

(52) U.S. Cl. CPC G06Q 40/08
USPC 705/4

(57) ABSTRACT

The present application discloses systems and methods for providing group insurance. An exemplary insurance system identifies or manages data relating to group membership based on a web portal associated with the membership. The insurance system may develop one or more insurance products based on risks that are shared amongst members.

### CROSS-REFERENCE TO RELATED APPLICATIONS

This application claims the benefit of U.S. Provisional Application No. 61/730,309 filed Nov. 27, 2012, which is incorporated herein by reference in its entirety.

### TECHNICAL FIELD

Various embodiments of the present invention relate to insurance and, more particularly, to systems and methods for providing insurance to a group of individuals based on an interest shared amongst the individuals.

### BACKGROUND

Group insurance is conventionally provided at a discount rate to members of a group, based on membership in a common organization. Other group rate policies stem from employment as sponsored by the employer.

A key distinction between group insurance and individual insurance is that, for group insurance, risk is spread throughout the entire group. In many instances, this can result in lower insurance premiums for individuals within a group.

### SUMMARY OF THE INVENTION

The present invention is directed to a computer-implemented method and/or an insurance system wherein the system compiles data associated with a group of individuals with a shared interest and evaluates said data to determine a group insurance policy. In one aspect of the present invention, said data is obtained from a social networking server and/or online community.

Another aspect of the present invention is to provide a group insurance policy at a lower cost than an individual policy, where the shared interest is a high-risk activity.

Yet another aspect of the present invention is to compile accurate and specific data and characteristics associated with a group at a low cost.

### BRIEF DESCRIPTION OF THE FIGURES

FIG. 1 illustrates a computing environment in which an insurance system or method may be implemented, according to an exemplary embodiment.

### DETAILED DESCRIPTION

To facilitate an understanding of the principles and features of embodiments of the present invention, those principles and features are explained with reference to their implementations in illustrative embodiments. The components described hereinafter as making up various elements of the invention are intended to be illustrative and not restrictive. Many suitable components that would perform the same or similar functions as the components described are intended to be embraced within the scope of the invention. Such other components can include, for example, components developed after development of the invention.

Exemplary embodiments of the invention are computer based systems and methods for providing group insurance in accordance with the unique attributes of a given group. In an exemplary embodiment, an insurance provider may identify potential insureds through a web portal, such as a website used for social networking of group-related activities.

In particular, social network sites such as Facebook™ allow the formation and enhanced communication of a diverse group of individuals brought together by some common interest. The use of this type of communication platform permits an exchange of information that is unprecedented.

This information is not only seamlessly collected, reflecting a high degree of accuracy with respect to the members within a group, but the collection process itself is both very efficient and inexpensive.

To illustrate the concept, the computer and network based social media allows individuals having a high risk activity, such as sky-diving, to connect online forming a community of individuals having a common but very risky hobby. These communities permit the sharing of experiences, concerns, dangers, safety practices, upcoming events and a nearly inexhaustible list of other attributes regarding sky-diving.

Normally, insurance for sky-diving is very difficult to obtain or prohibitively expensive. On an individualized basis, it is a risk that is nearly impossible to quantify—and thus insurers avoid writing policies or price it at a default high rate.

The foregoing problems are however avoided by the ad hoc “group” of sky-divers formed by Facebook memberships. In addition to the self selection process, the group communications become an incredibly rich source of group specific data that is highly valuable for underwriting insurance risk. Because the insurance is collected and organized by the individual members at no cost, the resulting pool of data is both very accurate and nearly cost free.

Using this “group” as an insurance pool provides the opportunity to offer policies at lower and more sustainable rates. Indeed, the very same web portal becomes a powerful vehicle for distributing and selling group policies to the collective membership—again in a very cost effective manner. Moreover, the groups for which insurance are sought can be completely self-organizing, as a result of the system's leveraging of social networking sites. For example, a previously uninsured activity may be insurable once a group reaches a certain threshold, and applies for group coverage in accordance with the present invention. In one embodiment, buttons or links to apply for group insurance coverage will be made available on group pages of social networking sites.

In a further exemplary embodiment, the insurance system is subscribed to, or otherwise receives updates related to membership data for the group. For example, and not limitation, if the organization portal utilizes a news feed, that feed may be received by the insurance system. Additionally, the insurance system may receive specific activities or other information about the group, which may also be provided by to the insurance system via a feed. Alternatively, the insurance system may automatically check the web data of the group periodically for new data. Further, a person may periodically check the web data, and the insurance system may receive updates from that person.

Given data related to a group's activities and membership, the insurance system may determine an insurance product, which may include a premium fee and a scope of coverage. In some embodiments, a human can view the data related to the group and manually create an insurance product on the insurance system. In some other embodiments, either the premium, of the scope of coverage, or both, or other aspects of an insurance product may be automatically calculated by the insurance system based on group data.

In some embodiments, the insurance system may calculate more than one available insurance product, where aspects of the available products are based in part on selection by members of the group. For example, the insurance system may provide a first insurance product with a low premium, a high deductable and minimal coverage scope; a second insurance product with a moderate premium, a low deductible, and moderate coverage scope; and a third insurance product with a high premium, a low deductible and wide coverage scope.

Thus, a group member may have multiple options of insurance products offered to the group. In some further embodiments, the insurance system may provide a range of options, where a group member may select a desired premium, deductible, or scope, and the insurance system may calculate the remaining aspects of the insurance product based on the selections and the available insurance products for the group.

The insurance system may provide various means by which a group member may become insured. For example, and not limitation, the insurance system may comprise or otherwise be associated with a website. The website may be in communication with a database comprising data related to the one or more insurance products associated with the group, or the website may comprise code for calculating aspects of an insurance product on demand. A group member may utilize the website to view data about insurance products related to his or her group, and may sign up for, or request coverage under, an insurance product via the website.

In some embodiments, the insurance system may provide a web interface with a predetermined library of operations. Thus, using the library, a website specific to the group, and managed by the group, may access the insurance system through the provided web interface. The group website may thereby provide insurance quotes to an individual in the group.

The insurance system may further include an administrative or customer support module. This module may enable a representative of an insurance provide, associated with the insurance system, to manage insurance coverage. The administrative module may provide various operations. For example, and not limitation the module may accept input from the representative to manage or modify insurance products, approve requested coverage, request additional information, or perform other actions; the module may transmit approvals to group members; or the module may transmit requests for additional information to group members.

The invention described above may be operational with one or more general purpose or special purpose computing system environments or configurations. Examples of well-known computing systems, environments, or configurations that may be suitable for use with the invention include, but are not limited to: personal computers, server computers, hand-held or laptop devices, tablet devices, smartphones, multiprocessor systems, microprocessor-based systems, set top boxes, programmable consumer electronics, household and commercial appliances, vehicles and other networked transportation systems, network personal computers, minicomputers, mainframe computers, distributed computing environments that include the above systems or devices, and the like.

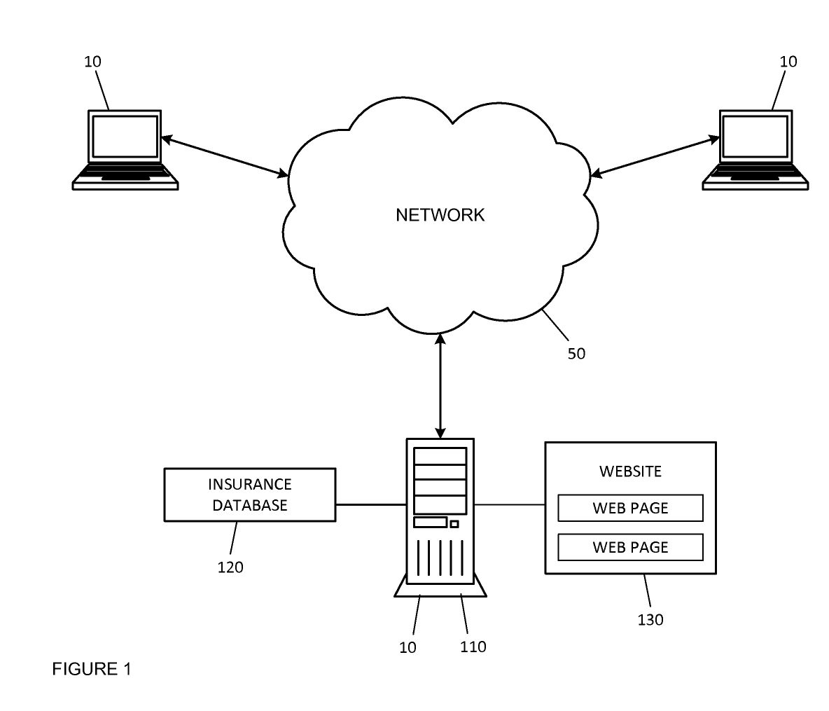

FIG. 1 illustrates a computing environment in which an insurance system or method may be implemented, according to an exemplary embodiment. As shown in FIG. 1, various embodiments of the insurance systems and methods may operate on one or more computer systems 10 and, in some embodiments, may communicate over a network 50. For example, and not limitation, an insurance server 110 may be a computer system 10 in communication with an insurance database 120. The insurance server 110 may thus perform various operations of the invention and may communicate information about insurance products to one or more client computer systems 10 over the network 50. In some cases, the client computer systems 10 may communicate with the insurance server 110 via a website 130 provided at least in part by the server 110.

Components of an exemplary computer system 10 may include, but are not limited to, an input device or devices, an output device or display, a processing unit, a system memory, and a system bus that couples various system components including the system memory, processing unit, and input and output devices. The system bus may be one or more of several types of bus structures, including a memory bus or memory controller, a peripheral bus, and a local bus using at least one of a variety of bus architectures.

The computer system 10 typically includes a connection or access to a variety of non-transitory computer-readable media. Computer-readable media may be available media accessible by the computer and may include volatile or nonvolatile media, and removable or non-removable media. By way of example, and not limitation, computer-readable media may comprise computer storage media and communication media. Computer storage media may store information such as computer-readable instructions, data structures, program modules or other data. Computer storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, networked or “cloud” storage, or other medium that can be used to store the desired information and that may be accessed by the computer. Communication media typically embodies computer-readable instructions, data structures, program modules, or other data in a modulated data signal and includes information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, or other wireless media. Various combinations of the above may also be included within the scope of computer-readable media.

As shown in FIG. 1, the computer system 10 may operate in a networked environment using logical connections to one or more remote computers. Each remote computer may be a personal computer, server, router, hand-held or laptop device, tablet device, smartphone, multiprocessor system, microprocessor-based system, set-top box, programmable consumer electronic, household or commercial appliance, vehicle or other networked transportation system, or peer device or other common network node, and may typically include many or all of the elements described above relative to the computer system. The network 50 may comprise one or more of local area networks (LAN) or wide area networks (WAN), but may also include other networks such as cellular and digital wireless networks. Such networking environments are commonplace in offices, enterprise-wide computer networks, intranets, and the Internet.

For ease of exposition, not every step or element of the present invention is described herein as part of software or a computer system 10, but those skilled in the art will recognize that each step or element may have a corresponding computer system 10 or software component. Such computer systems 10 and software components are therefore enabled by describing their corresponding steps or elements (that is, their functionality), and are within the scope of the insurance systems and methods. In addition, various steps or elements of the insurance systems and methods may be stored in one or more non-transitory storage media and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after development of the present invention.

1. A computer-implemented method, comprising:
receiving at a server, via a distributed network, data associated with a group, wherein said group comprises one or more individuals with a common interest;
inputting said data to an insurance database, wherein the data of the insurance database is used for underwriting insurance risk;
evaluating said data to determine an insurance policy based on characteristics associated with said group; and
outputting, via the distributed network, said insurance policy to the one or more individuals of the group.

2. The method of claim 1 wherein said data associated with said group is received from a social networking server.

3. The method of claim 1 wherein said common interest is a high-risk activity.

4. An insurance system comprising:
a server comprising a data processor programmed to
receive at the server, via a distributed network, data associated with a group, wherein said group comprises one or more individuals with a common interest;
input said data to an insurance database, wherein the data of the insurance database is used for underwriting insurance risk;
evaluate said data to determine an insurance policy based on characteristics associated with said group;
output, via the distributed network, the insurance policy to the one or more individuals of the group.
